(19) United States
(12) Patent Application Publication
(10) Pub. No.: US 2020/0086591 A1
(43) Pub. Date: Mar. 19, 2020

(54) Injection box for a pultrusion system for producing fibre-reinforced plastic profiles, in particular plastic rods

(71) Applicant: KRAUSSMAFFEI TECHNOLOGIES GMBH, München Bayern (DE)

(72) Inventor: Josef Renkl, Markt Indersdorf (DE)

(21) Appl. No.: 16/494,334

(22) PCT Filed: Mar. 20, 2018
(86) PCT No.: PCT/EP2018/056983

§ 371 Date: Sep. 16, 2019

(30) Foreign Application Priority Data
Mar. 31, 2017 (DE) 10 2017 106 940.2

(51) Int. Cl. B29C 70/52; B29C 70/54

(52) U.S. Cl. CPC B29C 70/526; B29L 2031/06; B29C 70/54; B29C 70/523

(57) ABSTRACT

An injection box for a pultrusion system, the injection box comprising: a housing which has at least one fibre supply opening for supplying fibres, in particular glass fibres, carbon fibres or aramid fibres; an injection connection provided on the housing for injecting a liquid matrix material; and a delivery opening for delivering the fibres impregnated with the matrix material to a curing tool; wherein the output opening has a substantially circular cross-section.

The present invention relates to an injection box for a pultrusion system, wherein the injection box comprises:
a housing which has at least one fibre supply opening for supplying fibres, in particular glass fibres, carbon fibres or aramid fibres;
an injection connection provided on the housing for injecting a liquid matrix material; and
a delivery opening for delivering the fibres impregnated with the matrix material to a curing tool.

The invention further relates to a pultrusion system with such an injection box and a fibre-reinforced plastic profile, in particular plastic rod, which is produced by means of such a pultrusion system.

Fibre-reinforced profiles in the form of elongated rods are used as reinforcement during construction. Here, for example, glass fibres are used, which are bonded with a vinyl ester resin. Compared to conventional reinforcement rods made of steel, they offer not only the advantage of a distinctly lower weight, but—in contrast to steel—they are also corrosion-resistant and can therefore be used in chemically aggressive environments. In addition, glass fibres—unlike steel—are not electrically conductive and a non-magnetic, so that corresponding reinforcement rods are suitable for the construction of housings and bases of high energy systems, e.g. switching systems, steelworks, aluminium smelters, electrical substations etc.

Such fibre-reinforced plastic rods can be produced in different lengths, also endlessly, by pultrusion.

Pultrusion or continuous drawing is a method known for several decades for the continuous production of endless, fibre-reinforced plastic profiles with a uniform cross-section. Here, fibres, which are combined into bundles, so-called rovings, are impregnated with a thermosetting or thermoplastic matrix material, for example polyurethane or epoxy resin, and are subsequently cured in a curing tool to form a fibre-reinforced plastic profile, mostly through a heat treatment. The fibres can be, in particular, glass, carbon, basalt or aramid fibres.

In the most prevalent pultrusion systems, the rovings are drawn by means of a drawing unit, a so-called puller, over deflection rollers through an open impregnating bath, which is filled with liquid matrix material. Following the open impregnating bath, the impregnated rovings enter into the curing tool, which usually comprises one or more heat chambers. Such pultrusion systems with an impregnating bath are used for the production of fibre-reinforced plastic profiles with different cross-sections and in particular also for the production of the mentioned elongated reinforcement rods.

To achieve a greater throughput, basically also pultrusion systems have been known for a few years in which the rovings are drawn without deflection through an injection box. The latter conventionally comprises a housing with at least one slit-shaped fibre supply opening for supplying the fibres at a front end of the housing in the direction of movement of the fibres, and an injection connection, provided on the housing, for injecting a liquid matrix material into the interior of the injection box. While the fibres are drawn by the drawing unit through the injection box, they are impregnated there with the pressurized liquid matrix material. The impregnated fibre portions leave the injection box through a slit-shaped delivery opening at a rear end of the housing in the direction of movement of the fibres, in order to subsequently enter into the curing tool.

Pultrusion systems with an injection box are used hitherto substantially for the production of fibre-reinforced plastic profiles which are composed from one or more plate-shaped sections. This is due to the hitherto available geometries of the injection boxes, in particular their slit-shaped supply- and delivery openings. A production of rod-shaped plastic profiles is hitherto not possible with such pultrusion systems.

It is therefore the object of the present invention to propose an injection box for a pultrusion system which also enables the production of rods.

According to the invention, this problem is solved in a generic injection box for a pultrusion system in that the delivery opening has a substantially circular cross-section. The impregnated fibre sections then leave the injection box in the form of an endless string with a circular cross-section, which can be cured in the subsequent curing tool to form an endless rod. The latter can then be cut into rods with the desired length by a conventional saw, in particular a so-called flying saw.

The delivery opening can be provided directly on the housing or on a calibration attachment which is able to be connected to the housing. In the first-mentioned case, the delivery opening is, as it were, a circular hole at the downstream rear end of the injection box in relation to the direction of movement of the fibres. In the last-mentioned case, a special calibration attachment is connected, for example by screwing, to the housing of the injection box at the downstream end. The fibres which are impregnated with matrix material then leave the housing of the injection box in the region of the connection site, enter there into the screwed-on calibration attachment as the rearmost part of the injection box, and leave the latter through a circular delivery opening. The particular advantage of this configuration lies in that by means of a set of several calibration attachments with delivery openings of different sizes, which for example can all be screwed into the same thread at the downstream end of the housing of the injection box, different diameters of the rods which are to be produced can be realized.

Preferably, in the injection box according to the invention provision is made that also the fibre supply opening has a substantially circular cross-section. This facilitates the uniform guidance of the fibres in the cavity within the injection box in the direction of the substantially circular delivery opening.

If here, in addition, the diameter of the fibre supply opening is greater than the diameter of the delivery opening, it is ensured that the fibres are compressed simultaneously in radial direction during the impregnating with matrix material in the cavity, which improves the stability of the rod which is to be produced.

In such an injection box according to the invention, provision can be made that a cross-section of a cavity in the housing of the injection box decreases substantially continuously from the fibre supply opening to the delivery opening. This leads to a further improvement and facilitation of the uniform guidance of the fibres in the cavity.

Alternatively, however, it is also conceivable that a cross-section of a cavity in the housing of the injection box increases from the fibre supply opening up to an intermediate position in the in the housing, and decreases from the intermediate position to the delivery opening, wherein then advantageously the intermediate position is to correspond to the position of the injection connection. Such a configuration improves the supply of the cavity in the interior of the injection box with matrix material, in particular at high throughputs.

In simple embodiments, the injection box according to the invention comprises a single cavity, however it is also possible according to the invention that a first plurality of cavities is provided in the housing of the injection box, substantially orthogonally to the direction of movement of the fibres. This increases the throughput of the entire pultrusion system in which such an injection box according to the invention is installed, because several endless strings of impregnated fibres can be produced simultaneously, over one another or adjacent to one another depending on the arrangement of the several cavities, and which are subsequently cured to form rods in a shared curing tool or in several curing tools, which are likewise arranged over one another or adjacent to one another.

In such an injection box according to the invention, the several cavities can be supplied with matrix material via a single injection connection. For this, the several cavities must be connected to one another, so that the liquid matrix material can flow from the single injection connection into all the cavities. Preferably, however, provision is made that a second plurality of injection connections is provided on the housing, wherein then expediently the first plurality is identical to the second plurality, so that an injection connection is assigned to each cavity. Hereby, a uniform supply of all cavities with matrix material is guaranteed, wherein all the injection connections can be supplied from a shared matrix material tank.

The invention further relates to a pultrusion system for the production of fibre-reinforced plastic rods which comprises an injection box as described above.

In a particularly expedient embodiment for the production of reinforcement rods, such a pultrusion system further comprises a winding device, which is designed to wind winding fibres and/or a winding band onto the fibres, which are impregnated with the matrix material, after their exit from the delivery opening of the injection box. In this way, an additional structure is applied onto the outer surface of the fibre-reinforced plastic rods, which enlarges the surface of the rods. Therefore, a larger contact surface is created for connection with the concrete which is to be reinforced, in order to increase the tear-out torques from the concrete.

In such a pultrusion system according to the invention, the winding device is expediently arranged before the curing tool in the direction of movement of the fibres. Therefore, the winding fibres and/or the winding band are wound onto the still damp fibres which are impregnated with matrix material, so that they can also become saturated with matrix material and, in the subsequent curing tool, enter into a secure connection with the fibre-reinforced plastic profile onto which they were wound.

In an advantageous configuration, the winding device is designed to receive at least one spool with winding fibres, wherein the winding fibres are preferably provided as a twisted roving. By the winding of the plastic rods with a twisted roving, it is ensured that the enlarged contact surface to which the concrete which is to be reinforced is to engage, has a particularly high stability, in order to permanently increase the tear-out torques from the concrete.

In order to keep the number of required starting materials as small as possible, the winding fibres and the fibres impregnated with the matrix material are expediently made from the same fibre material.

In a further development of the pultrusion system according to the invention, the winding device is designed to wind various types of winding fibres adjacent to one another onto the fibres, which are impregnated with the matrix material, after their exit from the delivery opening of the injection box. The various types can differ from one another according to the precise purpose of use of the reinforcement rod which is to be produced and of the concrete which is to be reinforced with regard to its material and/or with regard to the diameter of the respective rovings and/or with regard to further characteristics.

Basically, the winding device can comprise at least one rotary arm, which is able to be driven for rotation about a rotation axis which runs through the delivery opening of the injection box and substantially parallel to the direction of movement of the fibres which are impregnated with the matrix material. In particular in embodiments which are designed for the winding of various types of winding fibres adjacent to one another or respectively for the winding of winding fibres and of winding band adjacently or onto the winding fibres, the winding device can comprise several rotary arms.

In a further development, the pultrusion system according to the invention can comprise, furthermore, a pre-forming unit arranged before the fibre supply opening in the direction of movement of the fibres, which is designed to apply liquid matrix material onto the fibres before their entry into the injection box. Hereby, a particularly uniform wetting of the fibre rovings can be achieved, which are still spaced apart from one another in the region of the pre-forming unit and can therefore be reached by matrix material from all radial directions before they are compressed after entry into the injection box.

Here, the pre-forming unit can be designed to apply the liquid matrix material in a pressureless or pressurized manner onto the fibres. With a pressureless application, the matrix material can, for example, be dripped onto the fibre rovings. A pressure application requires a pre-forming unit which is substantially closed except for the openings for the entry and exit of the fibre rovings.

The invention further relates to a fibre-reinforced plastic profile, in particular a plastic rod, which is produced by pultrusion using a pultrusion system as described above.

Embodiments of the invention will be explained below as non-restrictive examples with the aid of the figures. There are shown herein:

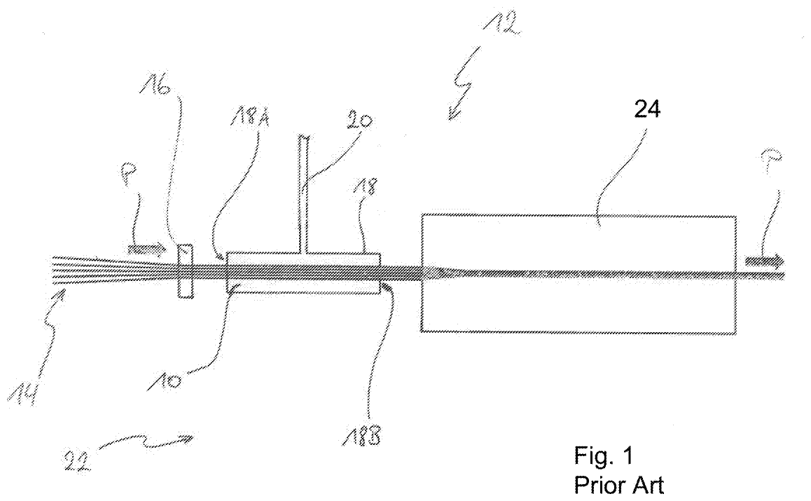

FIG. 1 a conventional injection box as part of a pultrusion system, shown in a diagrammatic side view, of the prior art;

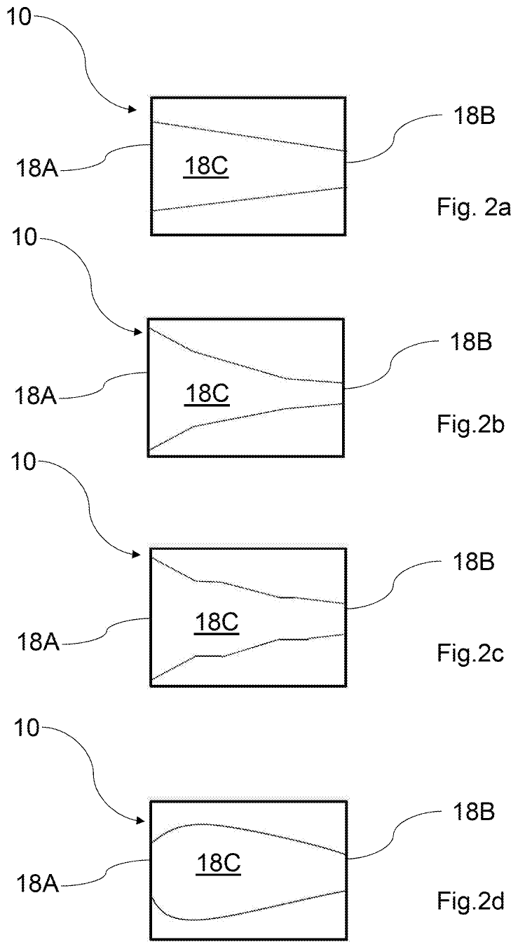

FIG. 2a-d diagrammatic cross-sectional views of four injection boxes according to the invention, with differently configured cavities;

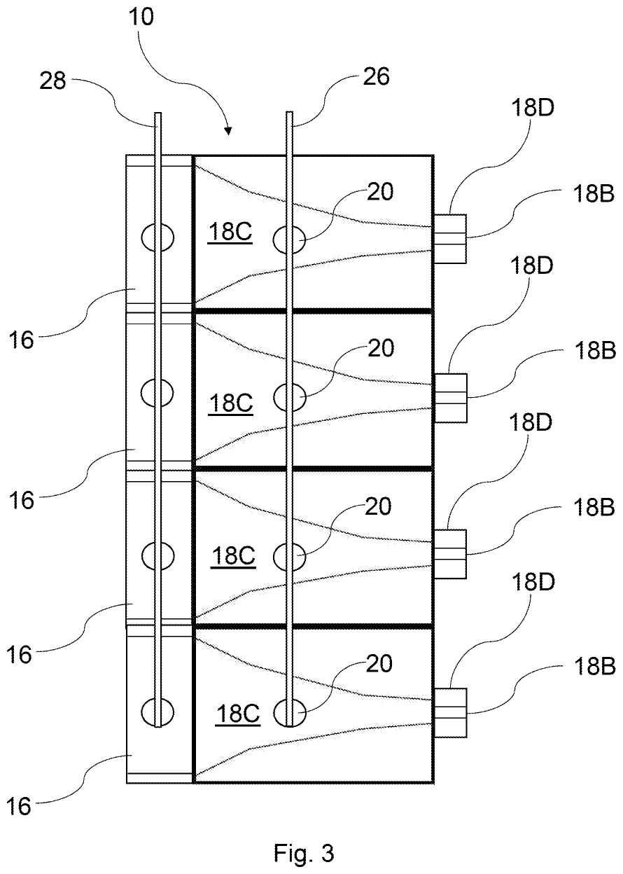

FIG. 3 a diagrammatic top view onto an injection box according to the invention with four adjacent cavities and respectively assigned pre-forming units and calibration attachments;

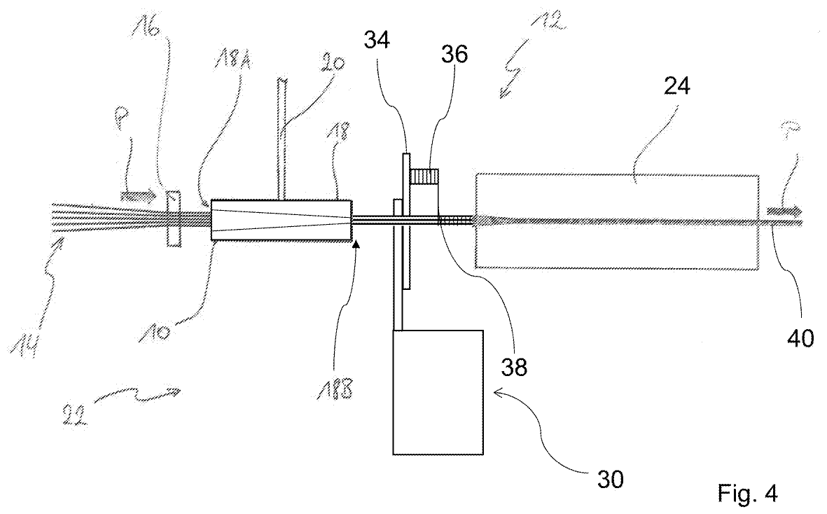

FIG. 4 a diagrammatic side view of a pultrusion system according to the invention;

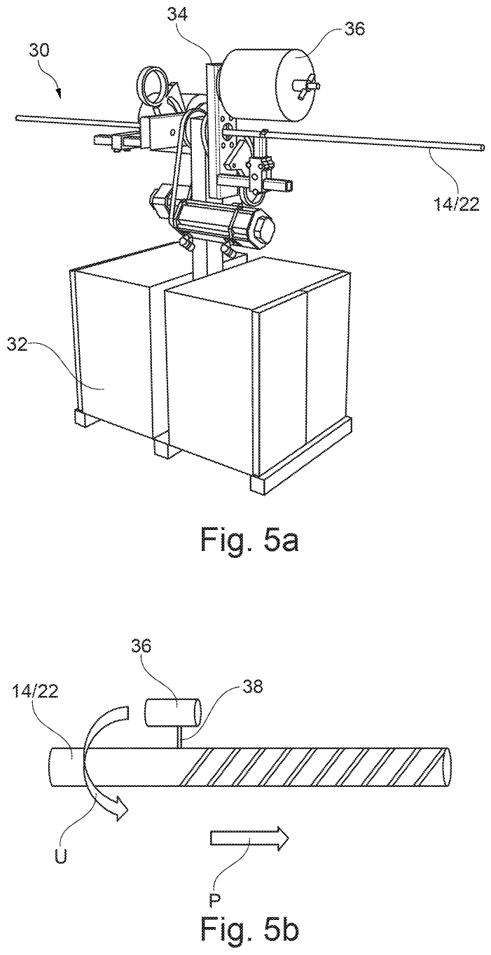

FIG. 5a a perspective view of a winding device of the pultrusion system according to the invention;

FIG. 5b a diagrammatic side view of the fibres, impregnated with the matrix material, after delivery from the delivery opening of the injection box in the region of the winding device;

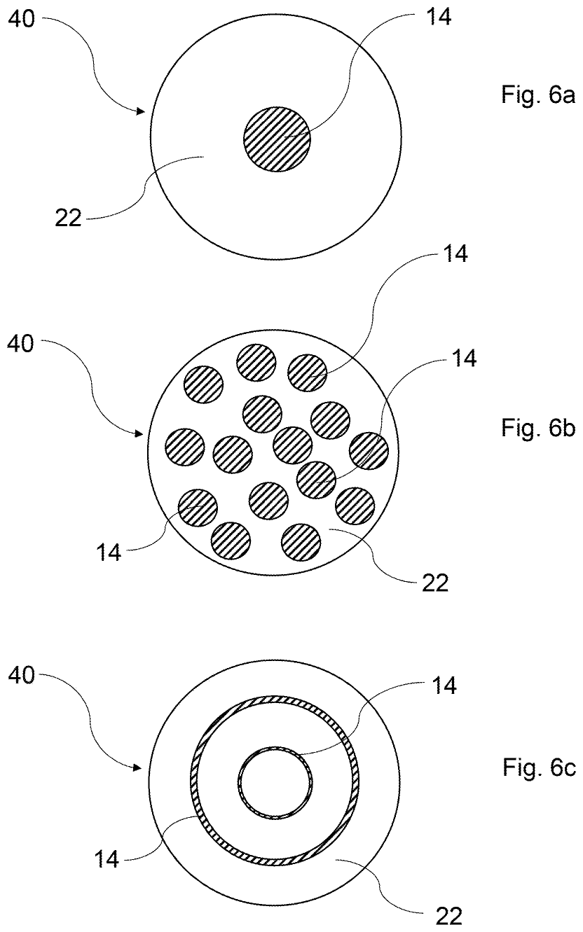

FIG. 6a a cross-sectional view through a fibre-reinforced plastic profile according to the invention with fibres arranged centrally along a longitudinal centre axis of the plastic matrix for a use as reinforcement rod with incorporated optical communication line;

FIG. 6b a cross-sectional view through a fibre-reinforced plastic profile according to the invention with fibres distributed uniformly over a cross-section of the plastic matrix for a use as a reinforcement rod with incorporated electric heating; and

FIG. 6c a cross-sectional view through a fibre-reinforced plastic profile according to the invention with fibres distributed in substantially concentric rings over a cross-section of the plastic matrix for a use as a reinforcement rod with an incorporated coaxial cable.

FIG. 1 shows a conventional injection box 10 in a pultrusion system 12 of the prior art in a diagrammatic side view. From a frame, not illustrated on the left in the figure, with fibre rolls, rovings 14 of endless fibres are drawn via a pre-forming unit 16 into the injection box 10. The pre-forming unit 16 can be e.g. a plate with parallel rows of holes through which the rovings 14 run in order to be drawn from there in a parallel manner and at uniform predetermined distances through a fibre supply opening 18A into a housing 18 of the injection box 10.

The drawing function is exerted by a drawing unit, a so-called puller, which is likewise not illustrated on the right in the figure. The direction of movement of the fibre rovings 14 is from left to right in FIG. 1, as is indicated by arrows P.

On one side of the housing 18, an injection connection 20 is provided for injecting a liquid matrix material 22. In the interior of the housing 18 of the injection box 10, the rovings 14 are therefore acted upon pressure with the liquid matrix material 22 and are impregnated. The impregnated rovings 14 are drawn out from the injection box 10 through a delivery opening 18B on the right-hand side of the housing 18 in FIG. 1, and enter into a subsequent curing tool 24, which is generally a heat chamber. The cured fibre-reinforced plastic profiles leave the curing tool 24 on the right-hand side in FIG. 1, as is indicated by the further arrow P.

The fibre supply opening 18A and the delivery opening 18B are configured so as to be slit-shaped in such conventional injection boxes 10, as vertical slits in the case shown in the side view of FIG. 1. In numerous other applications of the prior art, the slits are oriented horizontally.

FIG. 2a-d show diagrammatic cross-sectional views of four injection boxes 10 according to the invention, with differently configured cavities 18C. In all the cases which are shown, both the fibre supply opening 18A arranged on the left in the figures, and also the delivery opening 18B arranged on the right have a substantially circular cross-section, wherein the diameter of the fibre supply opening 18A is greater than that of the delivery opening 18B.

In the embodiment of FIG. 2a according to the invention, the cavity 18C narrows in the interior of the injection box in the form of a continuous truncated cone from the fibre supply opening 18A to the delivery opening 18B.

In the embodiment of FIG. 2b according to the invention, the cavity 18C narrows in the interior of the injection box in the form of three truncated cones, arranged one behind the other, with different opening angles from the fibre supply opening 18A to the delivery opening 18B.

In the embodiment of FIG. 2c according to the invention, the cavity 18C narrows in the interior of the injection box 10 in the form of five truncated cones, arranged one behind the other, with differing opening angles from the fibre supply opening 18A to the delivery opening 18B.

In the embodiment of FIG. 2d according to the invention, a cross-section of the cavity 18C in the housing of the injection box 10 increases from the fibre supply opening 18A up to an intermediate position in the housing, and decreases from the intermediate position to the delivery opening 18B. The cavity 18C therefore has a pear-shaped appearance. Expediently, in this case the injection connection 20, which is not shown in the figures, is arranged at the height of the intermediate position on the housing 18, i.e. in the region of the greatest cross-section of the cavity 18C.

FIG. 3 shows a diagrammatic top view onto an injection box 10 according to the invention with four adjacent cavities 18C as in the embodiment shown in FIG. 2b. Before each cavity 18C a pre-forming unit 16 is arranged, behind each cavity 18C a respectively associated calibration attachment 18D is mounted on the injection box 10, at the rear downstream end of which the substantially circular delivery opening 18B is situated.

In the embodiment shown in FIG. 3, each cavity 18C is provided with its own injection connection 20. The four injection connections 20 are supplied through a shared injection box supply line 26 with liquid matrix material 22 from a matrix material tank.

From the same tank, not illustrated in the figure, matrix material 22 can also be directed via a pre-forming unit supply line 28 to the four pre-forming units 16, in order to drip down there onto the fibre rovings 14, before they are drawn into the injection box 10. In this way, the rovings 14 can be acted upon all around with liquid matrix material 22, before they are compressed in the respective cavity 18C of the injection box 10. Therefore, it is ensured that the rovings 14 are not only wetted by matrix material 22 on their exposed outer side, but over their entire circumference, which improves the complete as possible impregnating of the rovings 14 with matrix material 22.

In the embodiment shown in FIG. 3, the through-duct of each calibration attachment 18D, the cross-section of which corresponds to that of the delivery opening 18B, is illustrated to be considerably smaller than the cross-section at the rear downstream end of the cavity 18C. Each calibration attachment 18D can be exchanged for a different calibration attachment 18D with a different through-duct, for example with a through-duct, the cross-section of which corresponds to that at the rear downstream end of the cavity 18C, or an even larger through-duct. Hereby, reinforcement rods or other fibre-reinforced plastic profiles with different cross-sections can be produced.

FIG. 4 shows a diagrammatic side view of a pultrusion system 12 according to the invention, in which an injection box 10 according to the invention in accordance with the embodiment shown in FIG. 2a comes into use without an upstream pre-forming unit and without a calibration attachment.

In this pultrusion system 12 according to the invention, a winding device 30 is arranged between the delivery opening 18B, provided directly on the housing 18, of the injection box 10 and the curing tool 24. The winding device 30 is illustrated isolated in perspective in FIG. 5a. It comprises a drive unit 32, which drives a rotary arm 34 via a belt drive about a rotation axis which runs through the delivery opening 18B of the injection box 10 and substantially parallel to the direction of movement of the fibres 14 which are impregnated with the matrix material 22. At one end of the rotary arm 34 a spool 36 is mounted, on which a twisted roving 38 is wound.

While the fibres 14, impregnated with matrix material 22, are drawn by the puller out from the delivery opening 18B of the injection box 10 and through an opening in the rotary arm 34 in the region of its rotation axis, they are immediately subsequently wound by the winding device 30 with the twisted roving 38. In the diagrammatic illustration of FIG. 5b, the direction of movement of the fibres 14, impregnated with matrix material, is indicated by a straight arrow P from left to right, the winding direction being indicated by a curved arrow U. As this winding still takes place before the curing tool 24, the matrix material with which the fibres 14 are impregnated is still damp and penetrates into the twisted roving 38 which, as it were, becomes saturated with matrix material.

As shown in FIG. 4, the overall arrangement of fibres 14 impregnated with matrix material 22 and subsequently wound with the twisted roving 38 is drawn by the puller into the curing tool 24 and is cured there to a firm fibre-reinforced plastic profile 40.

By providing a further spool 36 on the rotary arm 34, for example at the other end of the rotary arm 34, two twisted rovings 38, for example of different materials, can be wound adjacent to one another onto the fibres 14 which are impregnated with matrix material 22. If applicable, the winding device can also have several rotary arms 34, in order to carry further spools 36 with twisted rovings 38 and/or with a winding band, which are to be wound adjacent to one another or on one another onto the fibres 14 which are impregnated with matrix material 22. In particular a continuous winding with a winding band which is electrically insulating or is shielding electromagnetic waves can be of importance when the produced fibre-reinforced plastic profile is provided with electrically conductive fibres 14 in its interior and/or with electrically conductive rovings 14 on its outer surface for signal transmission or current conduction.

Such possibilities for use of a fibre-reinforced plastic profile 40 according to the invention will be described below with the aid of FIGS. 6a-c, wherein in these figures, for reasons of clarity, the winding fibres or respectively the winding band are omitted.

FIG. 6a shows a cross-sectional view through a fibre-reinforced plastic profile 40 according to the invention for a use as a reinforcement rod with incorporated optical communication line.

The fibre-reinforced plastic profile 40 in the form of a rod comprises a cured plastic matrix of matrix material 22, into which a roving, i.e. a bundle of glass fibres 14 is embedded. In the embodiment which is shown, the glass fibres 14 run substantially centrally along a longitudinal centre axis of the plastic matrix. Such a central arrangement of the fibres 14 can be achieved without difficulty during production by pultrusion. A decentralized embedding of the glass fibres 14 into the plastic matrix parallel to the longitudinal centre axis of the plastic profile is, however, likewise possible, for example by displacement of the pre-forming unit 16 which is used. The illustrated fibre-reinforced plastic rod 40 can be used as a reinforcement rod in the erecting of buildings and, owing to the light-conducting characteristics of the glass fibres 14, permits at the same time a use as a data line for optical communication. In the case of incomplete curing in the curing tool 24, the fibre-reinforced plastic profile 40 illustrated in FIG. 6a can, however, also be used as a current line, for example an overhead line. In this case, a winding with an electrically insulating winding band by the winding device 30 is particularly advantageous.

FIG. 6b shows a cross-sectional view through another fibre-reinforced plastic rod 40 according to the invention, in which carbon fibres 14 are distributed uniformly over a cross-section of the plastic matrix. Owing to the electrical conductivity of the carbon fibres 14, this fibre-reinforced plastic profile can be used as a reinforcement rod in the erecting of buildings and, at the same time, can be used as electric heating.

Finally, FIG. 6c shows a cross-sectional view through a further fibre-reinforced plastic profile 40 according to the invention, in which fibres 14 are distributed in the form of substantially concentric rings over a cross-section of the plastic matrix. Such an arrangement is particularly advantageous for a use according to the invention as a coaxial cable, wherein the central conductor can also—similarly to the glass fibre roving of FIG. 6a—run along the longitudinal centre axis.

What is claimed is:

1. An injection box (10) for a pultrusion system (12), wherein the injection box (10) comprises:
a housing (18) with at least one fibre supply opening (18A) for supplying fibres (14);
an injection connection (20) provided on the housing (18) for injecting a liquid matrix material (22); and
a delivery opening (18B) for delivering the fibres (14) impregnated with the matrix material (22) to a curing tool (24);
characterized in that the delivery opening (18B) has a substantially circular cross-section.

2. The injection box (10) for a pultrusion system (12) according to claim 1, wherein the delivery opening (18B) is provided directly on the housing (18) or on a calibration attachment which is able to be connected to the housing (18).

3. The injection box (10) according to claim 1, wherein the fibre supply opening (18A) also has a substantially circular cross-section.

4. The injection box (10) according to claim 3, wherein the diameter of the fibre supply opening (18A) is greater than the diameter of the delivery opening (18B).

5. The injection box (10) according to claim 4, wherein a cross-section of a cavity in the housing of the injection box (10) decreases substantially continuously from the fibre supply opening to the delivery opening (18B).

6. The injection box (10) according to claim 4, wherein a cross-section of a cavity in the housing of the injection box increases from the fibre supply opening (18A) up to an intermediate position in the housing, and decreases from the intermediate position to the delivery opening (18B).

7. The injection box (10) according to claim 6, wherein the intermediate position corresponds to the position of the injection connection (20).

8. The injection box (10) according to claim 1, wherein in the housing (18) of the injection box (10) a first plurality of cavities is provided substantially orthogonally to the direction of movement of the fibres (14).

9. The injection box (10) according to claim 1, wherein on the housing (18) a second plurality of injection connections (20) is provided.

10. The injection box (10) according to claim 9, wherein the first plurality is equal to the second plurality, wherein an injection connection (20) is assigned to each cavity.

11. A pultrusion system (12) for producing fibre-reinforced plastic rods (40), comprising the injection box (10) according to claim 1.

12. The pultrusion system (12) according to claim 11, further comprising a winding device (30), which is designed to wind winding fibres (38) and/or a winding band onto the fibres (14), impregnated with the matrix material (22), after their exit from the delivery opening (18B) of the injection box (10).

13. The pultrusion system (12) according to claim 12, wherein the winding device (30) is arranged in the direction of movement of the fibres (14) before the curing tool (24).

14. The pultrusion system (12) according to claim 12, wherein the winding device (30) is designed to receive at least one spool (36) with winding fibres (38), wherein the winding fibres (38) are provided as a twisted roving.

15. The pultrusion system (12) according to claim 12, wherein the winding fibres (38) and the fibres (14) impregnated with the matrix material (22) are made from the same fibre material.

16. The pultrusion system (12) according to claim 12, wherein the winding device (30) is designed to wind different types of winding fibres (38) adjacent to one another onto the fibres (14) impregnated with the matrix material (22) after their exit from the delivery opening (18B) of the injection box (10).

17. The pultrusion system (12) according to claim 11, wherein the winding device (30) comprises at least one rotary arm (34), which is able to be driven for rotation about a rotation axis which runs through the delivery opening (18B) of the injection box (10) and substantially parallel to the direction of movement (P) of the fibres (14) impregnated with the matrix material (22).

18. The pultrusion system (12) according to claim 11, further comprising a pre-forming unit (16) arranged in the direction of movement of the fibres (14) before the fibre supply opening (18A), which pre-forming unit is designed to apply liquid matrix material (22) onto the fibres (14) before their entry into the injection box (10).

19. The pultrusion system (12) according to claim 18, wherein the pre-forming unit (16) is designed to apply the liquid matrix material (22) in a pressureless or pressurized manner onto the fibres (14).

20. A fibre-reinforced plastic profile comprising plastic rod (40), wherein said plastic rod is produced by pultrusion using the pultrusion system (12) according to claim 11.
